(19) United States
(12) Patent Application Publication
(10) Pub. No.: US 2019/0287157 A1
(43) Pub. Date: Sep. 19, 2019

(54) AUTOMATED E-COMMERCE ORDER MANAGEMENT ON BEHALF OF NETWORKS OF ASSISTANT DEVICES

(71) Applicant: Essential Products, Inc., Palo Alto, CA (US)

(72) Inventors: Andrew E. Rubin, Los Altos, CA (US); Niccolo De Masi, San Francisco, CA (US)

(21) Appl. No.: 15/984,014

(22) Filed: May 18, 2018

Related U.S. Application Data
(60) Provisional application No. 62/644,289, filed on Mar. 16, 2018.

(51) Int. Cl. G06Q 30/06; G06Q 30/02; G06Q 20/10; G06Q 20/30; G06Q 10/08

(52) U.S. Cl. CPC G06Q 30/0635; G06Q 30/0205; G06Q 10/083; G06Q 20/30; G06Q 20/102

(57) ABSTRACT

Introduced here are computer programs and associated computer-implemented techniques for developing, applying, and modifying location-aware purchasing algorithms that facilitate purchases of goods ordered using assistant devices. These purchasing algorithms can intelligently combine orders placed by multiple users to purchase the appropriate good(s) in bulk. Purchasing algorithms can take advantage of several benefits enabled by bulk ordering. For example, a purchasing algorithm may discover that some goods are available at lower prices as the number of items being ordered increases. As another example, a purchasing algorithm may discover that additional savings are available due to the increased efficiency of bulk delivery logistics.

### CROSS-REFERENCE TO RELATED APPLICATIONS

This application claims priority to U.S. Provisional Application No. 62/644,289, titled “E-Commerce Solutions for Networks of Assistant Devices” and filed on Mar. 16, 2018, which is incorporated herein by reference in its entirety.

### TECHNICAL FIELD

Various embodiments concern computer programs and associated computer-implemented techniques for developing, applying, and modifying location-aware purchasing algorithms that facilitate purchases of goods ordered using assistant devices.

### BACKGROUND

The Internet of Things (IoT) is the network of mobile devices, vehicles, home appliances, and other items embedded with electronics, software, sensors, and connectivity modules that enable these objects to exchange data with each other. Thus, the IoT allows for the internetworking of computing devices to enable sophisticated functionality. For example, computing devices configured for home automation can exchange data to allow for the manual control and/or automation of lighting systems, air conditioning systems, security systems, etc.

A networked home environment (also referred to as a “smart home environment”) can include one or more assistant devices that are configured to respond to speech. For example, an assistant device may receive, via a microphone, voice input indicative of a question posed by a user, and then provide the corresponding data to a computer server for analysis. The computer server can identify an appropriate response to the question, and then provide the corresponding data to the assistant device that outputs the appropriate response via a speaker. As another example, a user may provide a voice command to control another computing device that is communicatively connected to the assistant device, such as a light bulb, security camera, etc.

Accordingly, users and assistant devices can interact with one another via vocal commands. In some instances, voice data corresponding to the vocal commands is only examined locally (e.g., by an assistant device for security purposes). In other instances, voice data corresponding to the vocal commands is examined remotely (e.g., by a computer server that is communicatively connected to the assistant device). Thus, these interactions may be supplemented/facilitated by a computer server to ensure that assistant devices are able to respond to users in an appropriate, satisfying manner.

### BRIEF DESCRIPTION OF THE DRAWINGS

Various features and characteristics of the technology will become more apparent to those skilled in the art from a study of the Detailed Description in conjunction with the drawings. Embodiments of the technology are illustrated by way of example and not limitation in the drawings, in which like references may indicate similar elements.

FIG. 1A is a perspective view of an assistant device.

FIG. 1B is a high-level block diagram illustrating the architecture of an assistant device that is able to listen to speech in its vicinity, and then provide information relevant to the speech.

FIG. 2 illustrates a network environment that includes multiple assistant devices corresponding to different home environments.

FIG. 3A depicts a county that includes a series of towns.

FIG. 3B depicts a condominium building or apartment building that includes multiple assistant devices.

FIG. 4 depicts an example of a data structure (here, a table) that may be maintained in accordance with various embodiments.

FIG. 5 is a high-level flow diagram of a process illustrating how a network-connected server system can interact with an e-commerce platform via a middleware computer program.

FIG. 6A depicts an example of a checkout interface of an e-commerce platform (here, Amazon.com®) with which a middleware computer program may interact.

FIG. 6B depicts another example of a checkout interface of an e-commerce platform (here, Jet™) with which a middleware computer program may interact.

FIG. 6C depicts another example of a checkout interface of an e-commerce platform (here, Google Express™) with which a middleware computer program may interact.

FIG. 7 depicts a process for facilitating location-aware group purchasing that takes advantage of savings from bulk logistics for delivery.

FIG. 8 depicts a process for constructing a purchasing model that predicts the purchasing behaviors of users based on past orders for goods placed through assistant devices.

FIG. 9 depicts a process for automatically ordering goods (also referred to as “staple goods”) that are consistently required on a regular basis.

FIG. 10 is a block diagram illustrating an example of a processing system in which at least some operations described herein can be implemented.

The drawings depict various embodiments for the purpose of illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

Assistant devices (also referred to as “voice assistant devices,” “ambient assistant devices,” or “home assistant devices”) include integrated virtual assistants capable of interacting with users. Some assistant devices are configured for hands-free activation through the use of “hot words” or “wake words.” For example, the Amazon Echo® speaker can be configured to respond to “Alexa,” while the Google Home™ speaker can be configured to respond to “Ok Google” and “Hey Google.” Moreover, some assistant devices utilize a wireless communication channel to extend usage beyond audio playback, such as to control various other computing devices arranged throughout a home environment.

Each assistant device can have its own designated interfaces, features, and personal assistant that is controlled by an operating system. The operating system can facilitate secure communication between an assistant device and a network-connected server system that includes one or more computer servers. Thus, the computer server(s) responsible for supporting network connectivity of the operating system can readily learn about user preferences, habits, etc.

Some assistant devices allow users to place orders for certain goods. For example, a user may make a voice purchase request by verbally asking the personal assistant to order a specified good. As another example, a user may make a tactile purchase request by physically interacting with another computing device (e.g., a button associated with a specified good). When an order is placed by a user, the operating system executing on the assistant device will typically communicate characteristic(s) of the order to the network-connected server system. Examples of these characteristics include a good identifier, a user identifier, an assistant device identifier, a quantity, an authorization indication, etc.

While multiple users often place orders for the same good, the network-connected server system handles each of these orders separately. Thus, if ten users place identical orders for the same good, the network-connected server system will initiate, process, and complete ten separate orders with an electronic commerce (e-commerce) platform. But such action can quickly overburden the network-connected server system, particularly when the number of orders is in the thousands or millions. Other issues also accompany increases in the number of orders. For instance, each order initiated by the network-connected server system represents an opportunity for an unauthorized entity (also referred to as a “hacker”) to gain sensitive information. Examples of sensitive information include personal information (e.g., address) of a user, financial information (e.g., payment card details) of a user, login credentials for an e-commerce account, etc.

Introduced here, therefore, are computer programs and associated computer-implemented techniques for developing, applying, and modifying location-aware purchasing algorithms that facilitate purchases of goods ordered using assistant devices. These purchasing algorithms can intelligently combine orders placed by multiple users to purchase the appropriate good(s) in bulk.

Purchasing algorithms can take advantage of several benefits enabled by bulk ordering. For example, a purchasing algorithm may discover that some goods are available at lower prices as the number of items being ordered increases. As another example, a purchasing algorithm may discover that additional savings are available due to the increased efficiency of bulk delivery logistics. If multiple individuals in a specific geographical area order a certain good at a certain cadence (e.g., weekly or monthly) via assistant devices, then the network-connected server system connected to those assistant devices can aggregate the demand. Those skilled in the art will recognize that the operating system executed by these assistant devices could also perform the same tasks as the network-connected server system to which the assistant devices are communicatively connected. Examples of geographical areas include neighborhoods, towns, condominium/apartment buildings, etc.

Aggregation enables the network-connected server system to source the cheapest offering of the good, and then deliver in bulk to all individuals at the desired cadence. More specifically, the network-connected server system can scour different e-commerce platforms for the desired good, and then place a bulk order to achieve savings in comparison to a series of individual orders. In some embodiments, the network-connected server system offers a bulk order to one or more e-commerce platforms and negotiates a discount for the aggregated orders that would otherwise not be available.

Artificial intelligence and/or machine learning may also be employed to achieve predictive aggregation of orders. For example, these algorithms may learn of individuals' needs for household items, thereby creating a more efficient cycle of logistical savings. As another example, these algorithms may discover that the addition or subtraction of one or more orders may result in greater savings. For instance, by waiting for a sixth order, the network-connected server system may be able to take advantage of a sale on groupings of three. These savings can be discovered by simulating different order configurations with each e-commerce platform, and then selecting the order configuration that results in the lowest price per unit.

Embodiments may be described with reference to particular computer programs, system configurations, networks, etc. However, those skilled in the art will recognize that these features are equally applicable to other computer program types, system configurations, network types, etc. For example, while an assistant device may be described as residing within a “home environment,” the assistant device could reside in other types of environments (e.g., office environments and public environments).

Moreover, the technology can be embodied using special-purpose hardware (e.g., circuitry), programmable circuitry appropriately programmed with software and/or firmware, or a combination of special-purpose hardware and programmable circuitry. Accordingly, embodiments may include a machine-readable medium having instructions that may be used to program a computer server to examine purchase requests submitted by multiple users via multiple assistant devices located in close proximity to one another, parse the purchase requests to identify a good shared in common by at least two purchase requests, initiate a bulk order for the good, etc.

### Terminology

References in this description to “an embodiment” or “one embodiment” means that the particular feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the words “comprise” and “comprising” are to be construed in an inclusive sense rather than an exclusive or exhaustive sense (i.e., in the sense of “including but not limited to”). The terms “connected,” “coupled,” or any variant thereof is intended to include any connection or coupling between two or more elements, either direct or indirect. The coupling/connection can be physical, logical, or a combination thereof. For example, devices may be electrically or communicatively coupled to one another despite not sharing a physical connection.

The term “based on” is also to be construed in an inclusive sense rather than an exclusive or exhaustive sense. Thus, unless otherwise noted, the term “based on” is intended to mean “based at least in part on.”

The term “module” refers broadly to software components, hardware components, and/or firmware components. Modules are typically functional components that can generate useful data or other output(s) based on specified input(s). A module may be self-contained. A computer program may include one or more modules. Accordingly, a computer program may include multiple modules responsible for completing different tasks or a single module responsible for completing all tasks.

When used in reference to a list of multiple items, the word “or” is intended to cover all of the following interpretations: any of the items in the list, all of the items in the list, and any combination of items in the list.

The sequences of steps performed in any of the processes described here are exemplary. However, unless contrary to physical possibility, the steps may be performed in various sequences and combinations. For example, steps could be added to, or removed from, the processes described here. Similarly, steps could be replaced or reordered. Therefore, descriptions of any processes are intended to be open-ended.

### Technology Overview

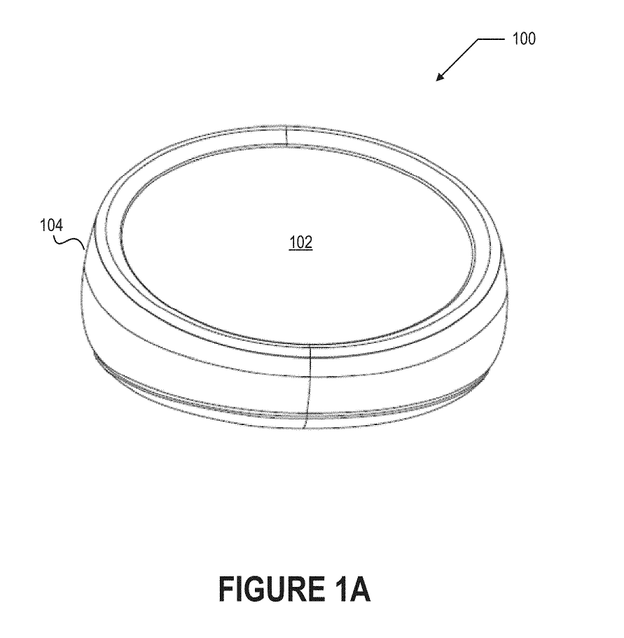

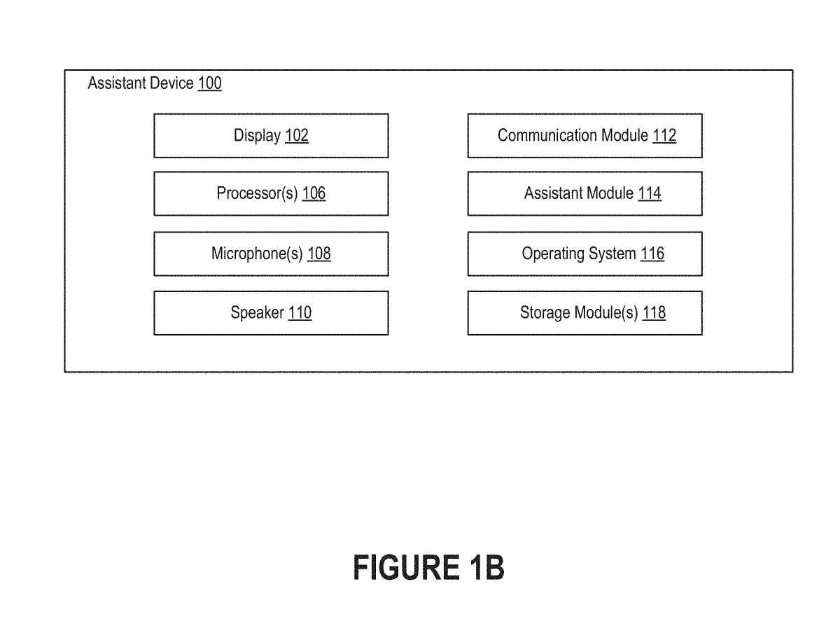

FIG. 1A is a perspective view of an assistant device 100. The assistant device 100 can include a display 102 set within a housing 104 designed to protect sensitive internal components from damage.

Some embodiments of the assistant device 100 include a power cable (not shown) that extends through the housing 104. The power cable may include one or more electrical conductors held together with an outer thermoplastic sheath. For example, the power cable may include copper conductor(s) of 6-14 gauge wire having a plug connected at one end. Some embodiments of the assistant device 100 include a power port that is accessible through the housing 104. In such embodiments, a power cable can be detachably connected to the power port. Other embodiments of the assistant device 100 include a power receiver that enables power to be wirelessly transferred to the assistant device 100.

The display 102 can be configured to present information relevant to the user(s) of the assistant device 100. In some embodiments, the display 102 is configured to automatically present certain types of information (e.g., the current time, upcoming scheduled events, weather, etc.) on a periodic or continual basis. Additionally or alternatively, the display 102 may be configured to present relevant information responsive to detecting a user inquiry. For example, if a user asks a question regarding an upcoming event, the display 102 may present information related to the upcoming event. In some embodiments, the display 102 is a touch-sensitive display capable of receiving touch input.

FIG. 1B is a high-level block diagram illustrating the architecture of an assistant device 100 that is able to listen to speech in its vicinity, and then provide information relevant to the speech. The assistant device 100 can include a display 102, one or more processors 106, one or more microphones 108, a speaker 110, a communication module 112, an assistant module 114, an operating system 116, and one or more storage modules 118. In some embodiments a single storage module includes multiple computer programs for performing different operations (e.g., speech recognition, noise reduction, filtering), while in other embodiments each computer program is hosted within a separate storage module.

The processor(s) 106 can execute modules (e.g., the assistant module 114) from instructions stored in the storage module(s) 118, which can be any device or mechanism capable of storing information.

The microphone(s) 108 can be configured to record speech uttered by users in the vicinity of the assistant device 100. In some embodiments, the microphone(s) 108 are omnidirectional microphones designed to pick up sound from all directions. In other embodiments, the microphone(s) 108 are directional microphones designed to pick up sounds coming from a specific direction. For example, if the assistant device 100 is designed to be placed on a surface, then the assistant device 100 may include at least one microphone arranged to pick up sounds produced above the assistant device 100 and at least one microphone arranged to pick up sounds produced in front of the assistant device 100. A set of microphones could also be equally spaced to form a phased array able to capture highly directional audio to reduce captured noise and interference.

The speaker 110 can be configured to project audio that can be heard by user(s) located near the assistant device 100. For example, if a user poses a question to the assistant device 100, an answer to the question may be audibly projected by the speaker 110. Generally, the speaker 110 projects audio at a volume specified by a user. However, in some embodiments, the volume may be automatically modified based on audio captured by the microphone(s) 108. For example, if the assistant device 100 determines that audio captured by the microphone(s) 108 includes background noise (e.g., from other voices, television content, etc.) exceeding a certain threshold, then the assistant device 100 can increase the volume of audio projected by the speaker 110. Similarly, if the assistant device 100 determines that audio captured by the microphone(s) 108 includes little background noise, then the assistant device 100 can decrease the volume of audio projected by the speaker 110. Thus, audio projected by the speaker 110 can be calibrated based on, for example, audio recorded by the microphone(s) 108.

The communication module 112 can manage communications between various components of the assistant device 100. The communication module 112 can also manage communications between the assistant device 100 and another electronic device. For example, the communication module 112 may facilitate communication with a mobile phone, wireless access point (WAP), network-connected server system, etc. In some embodiments, the communication module 112 is configured to transmit voice data indicative of speech recorded by the microphone(s) 108 to a network-connected server system that includes one or more computer servers for further review.

Generally, the assistant device 100 will record a stream of media content that includes both conversation regions and pause regions. The processor(s) 108 can then parse the stream of media content to identify distinct questions, commands, etc. In some embodiments, the assistant device 100 creates a separate media file for each question, command, etc. For example, the assistant device 100 may be configured to begin recording upon recognizing a keyword (e.g., “Hello” or “Wake”), detecting recognizable sounds, detecting the presence of certain computing devices (e.g., the mobile phone of a frequent user), etc.

The communication module 112 may be configured to continually or periodically transmit voice data to another electronic device. For example, the communication module 112 may be configured to only transmit conversation regions of media content to a network-connected server system. As another example, the communication module 112 streams voice data to the network-connected server system in real time. In such embodiments, the network-connected server system may be responsible for parsing the media content to identify distinct questions, commands, etc.

The processor(s) 106 can process data generated by the assistant device 100. For example, if the microphone(s) 108 generate voice data, then the processor(s) 106 may apply noise reduction algorithms or filtering algorithms to improve the signal-to-noise (SNR) ratio. The processor(s) 106 may also apply speech recognition algorithms to identify words within the voice data. Note that these tasks could instead performed by another electronic device (e.g., a computer server of the network-connected server system).

As noted above, the processor(s) 106 can also execute various computer programs. Here, for example, the processor(s) 106 are configured to execute an assistant module 114 and an operating system 116. The assistant module 114 can include logic for facilitating user interactions, while the operating system 116 can include logic for supporting basic functions (e.g., scheduling tasks, executing computer programs, and controlling peripherals). More specifically, the assistant module 114 may include the logic necessary to implement a personal assistant capable of providing information and/or performing concierge-type tasks based on voice input.

Generally, the operating system 116 is responsible for establishing a communication channel with the network-connected server system. The communication channel can be used by the assistant device 100 to transmit data indicative of orders for goods placed through the assistant device 100. Thus, when a user submits an order for a good (e.g., via a voice purchase request), the operating system 116 can transmit the information necessary to process the order to the network-connected server system. The assistant module 114 may also be communicatively coupled to the network-connected server system responsible for supporting the assistant device 100.

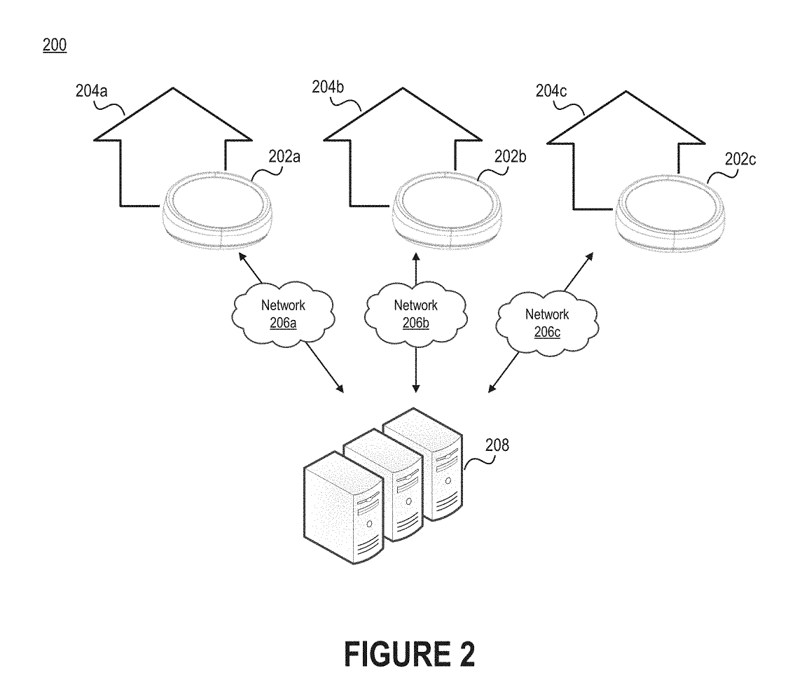

FIG. 2 illustrates a network environment 200 that includes multiple assistant devices 202a-c corresponding to different home environments 204a-c. Each assistant device can be configured to record speech uttered in the corresponding home environment, and then transmit voice data indicative of the recorded speech to a network-connected server system 208 (also referred to as an “order management platform”). In addition to managing orders for goods placed through the multiple assistant devices 202a-c, the network-connected server system 208 may also facilitate interactions with a personal assistant, broadcasts of digital content (e.g., by causing an assistant device to project audio media corresponding to a phone call), etc.

As shown in FIG. 2, the multiple assistant devices 202a-c and the network-connected server system 208 can be connected to one another via computer networks 206a-c. The computer networks 206a-c can include personal area networks (PANs), local area networks (LANs), wide area networks (WANs), metropolitan area networks (MANs), cellular networks, the Internet, etc. Additionally or alternatively, the multiple assistant devices 202a-c and the network-connected server system 208 may communicate with one another over a short-range communication protocol, such as Bluetooth® or Near Field Communication (NFC)

Each assistant device can have its own designated interfaces, features, and personal assistant that is controlled by an operating system. The operating system can facilitate secure communication between each of the multiple assistant devices 202a-c and the network-connected server system 208. Based on the data received from the multiple assistant devices 202a-c, the network-connected server system 208 can learn about the preferences and habits of the corresponding users.

Conventionally, each order placed through the assistant devices 202a-c would be handled separately by the network-connected server system 208. Thus, if three users placed identical orders for the same good through the three assistant devices 202a-c, the network-connected server system 208 would initiate, process, and complete three separate orders with an e-commerce platform. Introduced here, however, are computer programs and associated computer-implemented techniques for developing, applying, and modifying location-aware purchasing algorithms that facilitate purchases of goods ordered using assistant devices. These purchasing algorithms can intelligently combine orders placed through different assistant devices to purchase the appropriate good(s) in bulk.

Location-aware purchasing algorithms can take advantage of savings from bulk logistics for delivery. Here, for example, the different home environments 204a-c may be located in close proximity to one another in a certain geographical area. In some embodiments, the boundaries of the geographical area are predetermined. Examples of such geographical areas include neighborhoods, towns, counties, zip codes, condominium/apartment buildings, etc. In other embodiments, the boundaries of the geographical area are flexible. Thus, the network-connected server system 208 may dynamically determine which orders will be included in a bulk order based on the location of the assistant devices through which those orders were placed.

As further described below, orders for different goods placed through a single assistant device (e.g., assistant device 204a) need not necessarily be included in the same group. For example, an order for a common good (e.g., toilet paper or coffee) may be combined with other orders placed within a five-mile radius, while an order for a less common good (e.g., energy drinks or laundry detergent) may be combined with other orders placed within a ten-mile radius.

If a purchase request for a substantially similar good is submitted through at least two of the assistant devices 202a-c, then the network-connected server system 208 can automatically aggregate the demand on behalf of these users. Aggregation enables the network-connected server system 208 to identify the cheapest offering of the good, and then deliver in bulk to multiple users who have submitted a purchase request for the good. The network-connected server system 208 will typically only aggregate orders for the same good. However, in some embodiments, the network-connected server system 208 is configured to also aggregate orders for substantially similar goods. Examples of substantially similar goods include different brands of the same good.

However, the network-connected server system 208 may treat orders differently based on whether those orders are for goods where brand variation is likely to influence purchasing decisions. For example, the network-connected server system 208 may opt to combine orders for paper towels, toilet paper, or laundry detergent, but may opt not to combine orders for coffee, energy drinks, etc. Moreover, the network-connected server system 208 may treat orders differently based on the degree of similarity between different brands of the same good. For example, the network-connected server system 208 may have access to a list of goods of comparable quality (e.g., high-quality paper towels, medium-quality paper towels, and low-quality paper towels). In such embodiments, the network-connected server system 208 may only combine orders for goods of a similar quality. Thus, the network-connected server system 208 can avoid ordering a good having a substantially different quality than what is expected by a user who placed an order.

Similar techniques can be employed for goods set to be delivered on a periodic basis. For example, the network-connected server system 208 may intelligently negotiate lower prices for all users who wish to receive a substantially similar good at a similar cadence (e.g., weekly or monthly).

As further described below, the network-connected server system 208 can scour different e-commerce platforms for the desired good, and then place a bulk order to achieve savings in comparison to a series of individual orders. In some embodiments, the network-connected server system 208 offers a bulk order to one or more e-commerce platforms and negotiates a discount for the aggregated orders that would otherwise not be available.

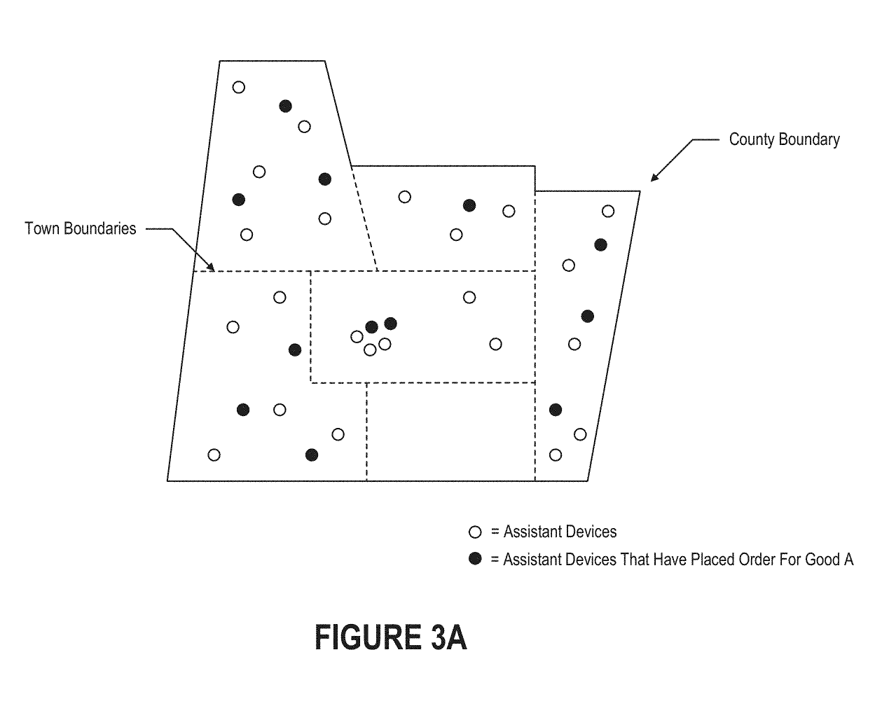

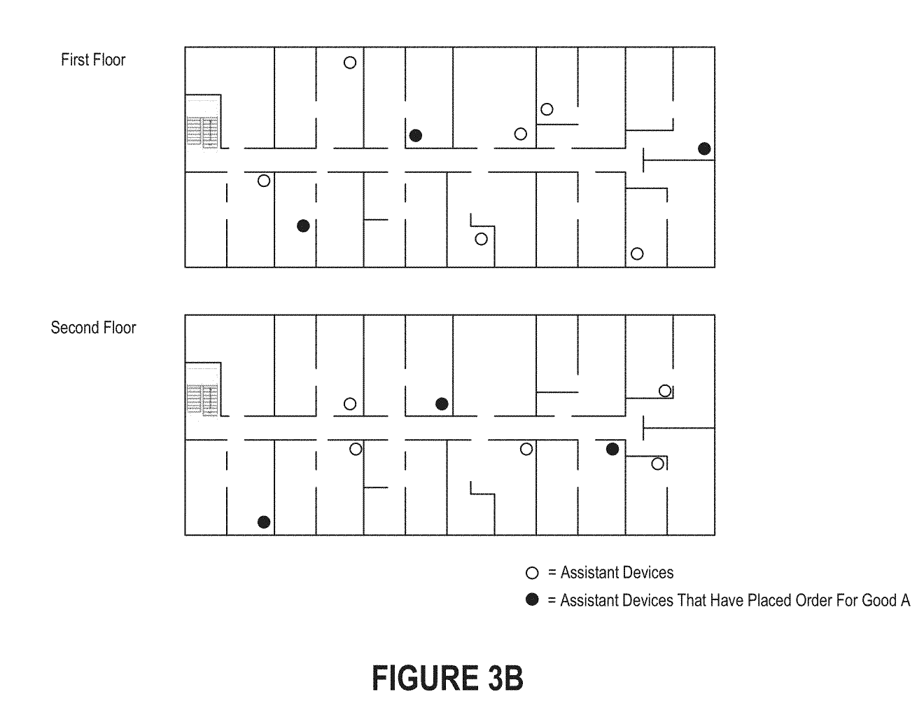

FIGS. 3A-B illustrate how a network-connected server system can identify multiple assistant devices that have been used to place an order for a substantially similar good. To achieve a lower per-unit price, the network-connected server system can place a bulk order for the substantially similar good on behalf of the multiple assistant devices.

FIG. 3A, for example, depicts a county that includes a series of towns. Assistant devices may be located throughout the county at varying densities. Here, for example, some towns have a high density of assistant devices, while other towns have a low density of assistant devices. Those skilled in the art will recognize that a subset of assistant devices have been shown for the purpose of illustration. Counties and towns will often include a much higher number of assistant devices than shown here (e.g., hundreds or thousands of assistant devices). FIG. 3B, meanwhile, depicts a condominium building or apartment building that includes multiple assistant devices.

In some embodiments, the boundary of a geographical area corresponding to a batch order is predetermined. For example, a network-connected server system may automatically batch all orders for a substantially similar good that are placed within a county/town (as shown in FIG. 3A) or a building (as shown in FIG. 3B). In other embodiments, the boundary of the geographical area corresponding to a batch order can vary in an elastic manner. For example, an order for a common good (e.g., toilet paper or coffee) may be combined with other orders placed within the same town, while an order for a less common good (e.g., energy drinks or laundry detergent) may be combined with other orders placed within the same county. The determination of how common a good is may depend on the number of brands available, the differences in quality between those brands, etc. Thus, while items like toilet paper and laundry detergent may be ordered at a similar cadence, the network-connected server system may determine that there is greater degree of similarity between different brands of toilet paper than different brands of laundry detergent.

The network-connected server system can discover the location of each assistant device from which it receives an order in several different ways. For example, an assistant device may report its location when submitting an order to the network-connected server system by including location coordinates, such as Global Positioning System (GPS) coordinates, physical address, etc. These location coordinates may be generated by the assistant device itself or a computing device that is communicatively connected to the assistant device. For instance, a mobile phone or wireless access point (WAP) connected to the same network (e.g., a wireless home network) as the assistant device may transmit the location coordinates to the assistant device. As another example, the network-connected server system may determine location of the assistant device from its the IP address if the network-connected server system is able to access an appropriate lookup table. For instance, the network-connected server system may have access to a service that maps IP addresses to corresponding cities, states, regions, zip codes, area codes, location coordinates, countries, or any combination thereof. Such location-identifying information could also be derived from network data, Internet Service Provider (ISP) data, etc.

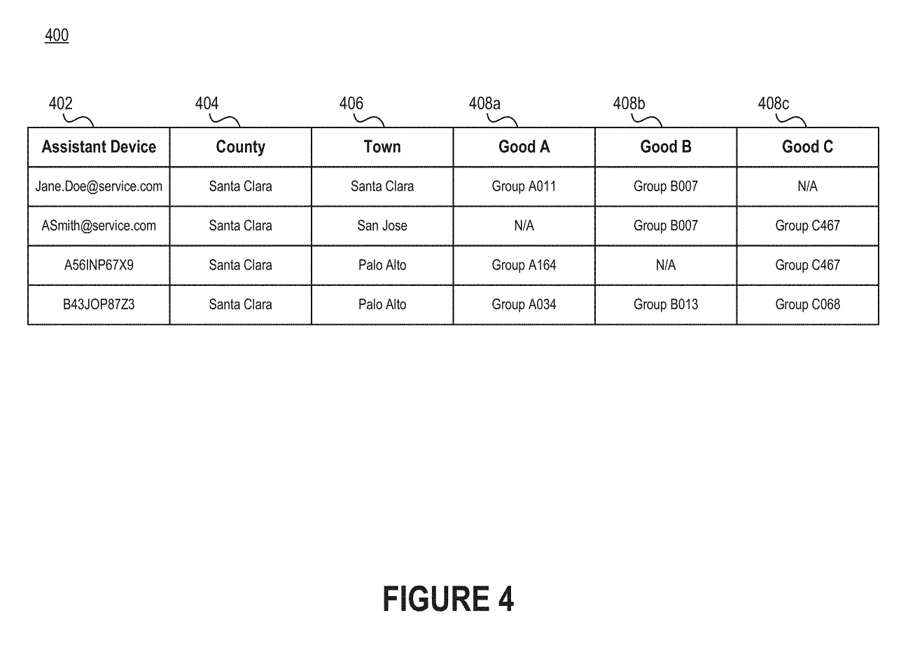

FIG. 4 depicts an example of a data structure (here, a table 400) that may be maintained in accordance with various embodiments. When a network-connected server system receives an order from an assistant device, the network-connected server system can create a new record for the assistant device. Alternatively, the network-connected server system may modify an existing record should one already exist for the assistant device. For example, the network-connected server system could modify an existing record by associating the assistant device with a new group for a particular good. Thus, the data structure may be dynamically updated as orders are received, assistant devices are connected to new networks, etc.

Each record in the table 400 will typically include several different types of information that are associated with an assistant device identifier 402. Each assistant device identifier uniquely identifies the corresponding assistant device from amongst all assistant devices that submitted orders to the network-connected server system. Examples of assistant device identifies include email addresses used to register for a service facilitated by the network-connected server system, collections of alphanumeric characters, media access control (MAC) addresses, Internet Protocol (IP) addresses, etc.

Each record in the table 400 may also specify the location of the corresponding assistant device. Here, for example, the table 400 includes the county 404 and town 406 in which the assistant devices reside. Additionally or alternatively, the tablet 400 may specify GPS coordinates, physical address (e.g., for billing or shipping purposes), the network on which the assistant device resides, etc.

Further yet, each record in the table 400 can specify the group(s) to which the corresponding assistant device belongs. Here, for example, an assistant device belonging to Jane.Doe@service.com is included in Group A011 for good A and Group B007 for good B. An assistant device belonging to ASmith@service.com also belongs to Group B007 for good B, though no order for good A has been placed through that assistant device. As shown in FIG. 4, each good can be associated with its own group(s) based on, for example, different brands, quality levels, etc. Thus, users may be in the same group for one good but different groups for another good.

Data structures such as these are generally more useful for goods that are ordered multiple times at a particular cadence. For example, the table 400 may enable the network-connected server system to readily identify which users should receive toothpaste once a month, granola bars once a week, etc. However, the network-connected server system could also maintain a table for those order that are placed a single time. In such embodiments, the network-connected server system may use the table to identify more appropriate advertisements (e.g., those related to past orders), prompt users to place a new order (e.g., for medication to be taken in accordance with a regimen), etc.

### Middleware E-Commerce Solutions

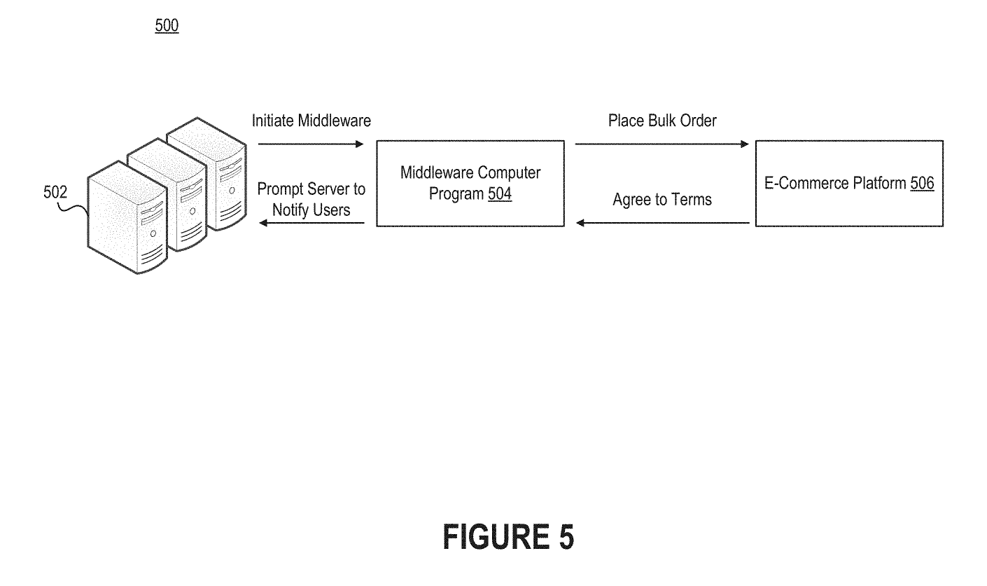

FIG. 5 is a high-level flow diagram of a process 500 illustrating how a network-connected server system 502 can interact with an e-commerce platform 506 via a middleware computer program 504.

Initially, the network-connected server system 502 receives purchase orders from multiple assistant devices for a substantially similar good. In some cases these purchase orders will be for identical goods, while in other cases these purchase orders will be for similar goods (e.g., different brands of toilet paper, paper towels, bottled water, etc.). If the purchase orders are for similar goods, the network-connected server system 502 may group purchase orders by quality of the desired goods. For example, the network-connected server system 502 may automatically combine orders for bottled water of a similar quality (e.g., those having an average value of less than $1.00 per bottle) and filter those orders for bottled water of a different quality (e.g., those having an average value of greater than $1.00 per bottle). As another example, the network-connected server system 502 may automatically combine orders for similar goods that share a feature in common (e.g., different brands of laundry detergent that each include bleach). In some embodiments, the network-connected server system 502 considers multiple criteria when determining which orders should be grouped together. For instance, the network-connected server system 502 may consider price, product features, and assistant device location, though these criteria may be weighted differently.

The network-connected server system 502 may notify the assistant device if an order placed on that assistant device is altered in such a manner. More specifically, the network-connected server system 502 can alert a corresponding user that a desired good has been replaced by a similar good. Such action provides the user an opportunity to cancel the order (e.g., by specifying that the similar good is not a suitable replacement for the designed good). In some embodiments the alerts are delivered by the assistant device (e.g., via a display or microphone), while in other embodiments the alerts are delivered by another computing device (e.g., a mobile phone that is communicatively connected to the assistant device or the network-connected server system 502). Thus, alerts could be delivered in the form of verbal alerts, tactile alerts (e.g., vibrations), or visual alerts (e.g., text messages, email messages, or push notifications).

Thereafter, the network-connected server system 502 can initiate a middleware computer program 504 designed to interface with an e-commerce platform 506 on which goods can be purchased. As further described below, the network-connected server system 502 may include a separate middleware computer program for each e-commerce platform with which it needs to interface. Examples of e-commerce platforms include Amazon.com®, Walmart®, Jet™, Google Express™, etc.

The middleware computer program 504 can then place a bulk order for the desired goods with the e-commerce platform 506. When placing the bulk order, the middleware computer program 504 may also negotiate the terms to identify the lowest per unit price.

In some embodiments, the negotiation process is completely automated. For example, the middleware computer program 504 may concurrently or simultaneously simulate placing a bulk order on multiple e-commerce platforms, and then identify the e-commerce platform offering the cheapest price. Moreover, because the desired goods are ordered by the network-connected server system 502 in bulk, rebate codes and/or discount codes may be available that otherwise could not be applied. The middleware computer program 304 can be configured to automatically apply these codes so that they are considered when identifying the lowest price.

In other embodiments, the negotiation process is at least partially completed by an administrator associated with the network-connected server system 502. For example, for bulk orders exceeding a certain size (e.g., 100 units) or value (e.g., $10,000), the administrator may be prompted to manually negotiate with a counterparty associated with the e-commerce platform 506. Manual negotiation may lead to lower prices than would otherwise be available. In fact, the e-commerce platform 506 may be able to offer lower prices than are available to the general public due to the increased efficiency of bulk delivery. Additional efficiencies (e.g., in processing, security, etc.) may be discovered when the bulk order is associated with a single payment. For example, rather than initiate a series of transactions between the e-commerce platform 506 and multiple users, the middleware computer program 504 may initiate a single transaction between the e-commerce platform 506 and the network-connected server system 502. In such embodiments, each user may instead transfer money to a service responsible for operating the network-connected server system 502.

After the lowest possible price has been established, the e-commerce platform 506 can acknowledge agreement to the terms offered by the middleware computer program 504 (or vice versa). After receiving confirmation of completion of the purchase, the middleware computer program 504 can prompt the network-connected server system 502 to notify the appropriate users. As noted above, the notification will typically be presented by the assistant devices through which the users placed their orders. However, the network-connected server system 502 could additionally or alternatively cause the notification to be presented by another computing device (e.g., a mobile phone that includes a mobile application associated with the assistant device, service responsible for operating the network-connected server system 502, or e-commerce platform 506). The notification may specify the price per unit, the total savings, the expected delivery date, etc.

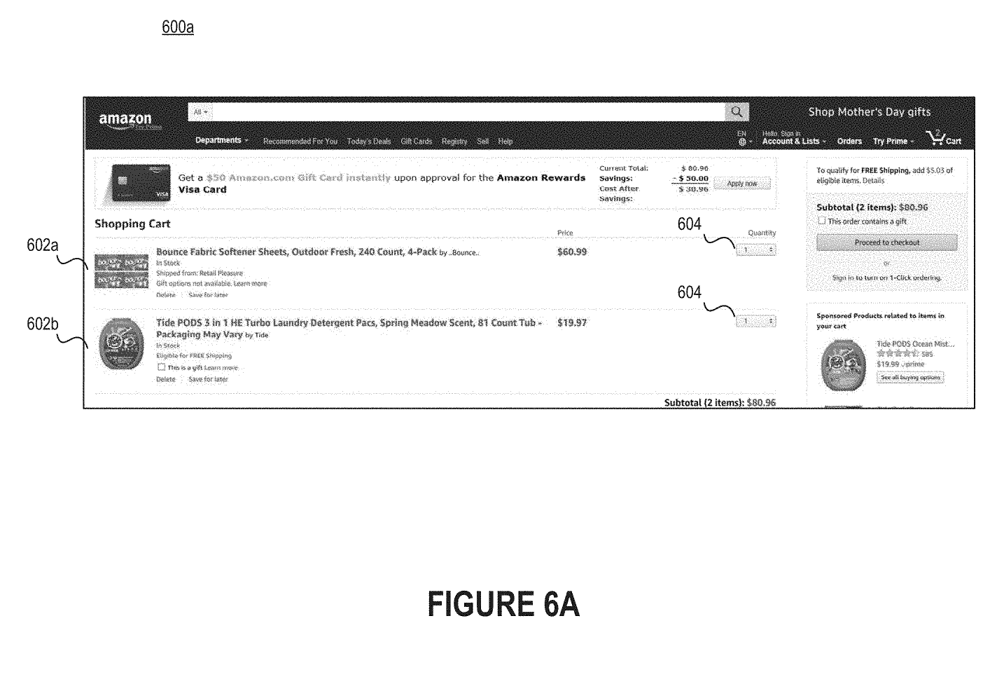

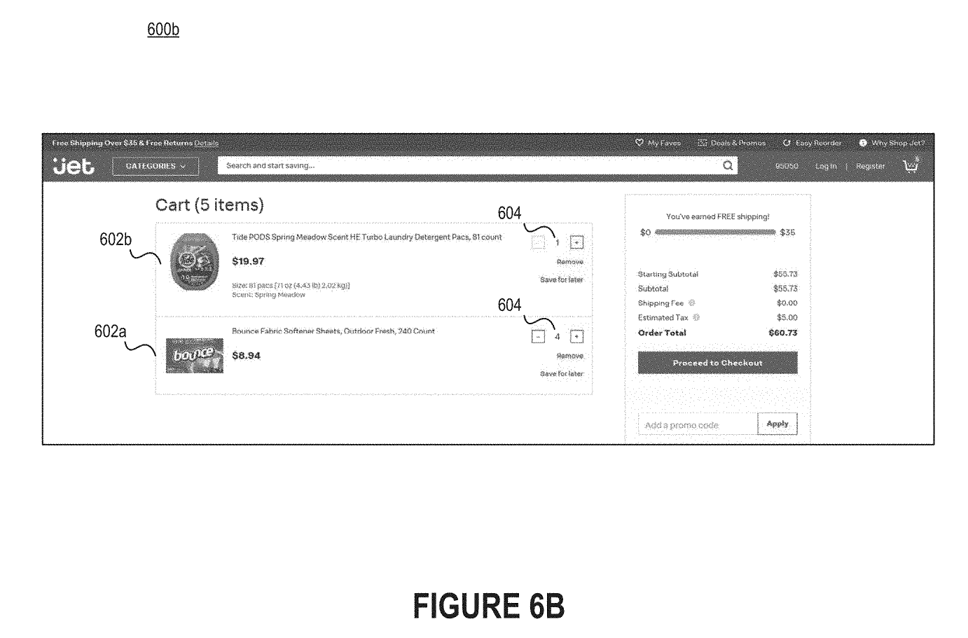

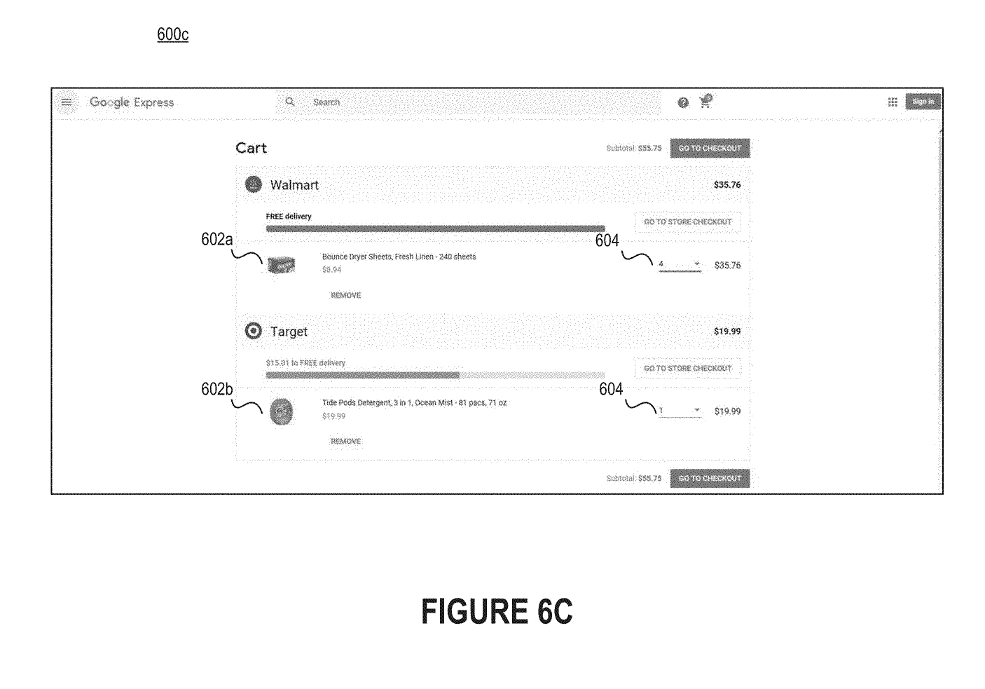

FIG. 6A depicts an example of a checkout interface 600a of an e-commerce platform (here, Amazon.com®) with which a middleware computer program may interact. FIG. 6B depicts another example of a checkout interface 600b of an e-commerce platform (here, Jet™) with which a middleware computer program may interact. FIG. 6C, meanwhile, depicts another example of a checkout interface 600c of an e-commerce platform (here, Google Express™) with which a middleware computer program may interact.

As noted above, the middleware computer program may browse goods offered for sale by the e-commerce platform, select one or more goods for bulk purchase, and then complete the bulk purchase. Here, for example, the middleware computer program has opted to complete a purchase for laundry detergent 602b and fabric softener sheets 602a.

To identify the lowest possible price of the good(s), the middleware computer program can perform several different tasks. In some embodiments, the middleware computer program examines some or all of the listings for the desired good(s) on the e-commerce platform. E-commerce platforms such as Amazon.com® may have several different merchants selling the same good. Therefore, the middleware computer program may identify which merchant has the necessary quantity in stock at the lowest price. The middleware computer program may also compare prices across different e-commerce platforms. Here, for example, the middleware computer program may discover that the subtotal for the same items is cheaper on Google Express™ than either Jet™ or Amazon.com®.

Additionally or alternatively, the middleware computer program may examine whether a deal is available for the desired good(s). In some embodiments, deals are discovered by parsing the content of the page on which the desired good(s) are advertised. For example, the middleware computer program may detect an advertisement while browsing an e-commerce platform (e.g., “20% off your first order with code SPRING20”). In other embodiments, deals are discovered by modifying the quantity 604 of goods to be purchased. For example, the middleware computer program may simulate various order configurations by modifying the quantity 604 of a given good to see what effect, if any, the modification has on the per unit price of the given good or the price of the purchase order as a whole. For instance, the order placed on Amazon.com® will qualify for free shipping upon increasing the total cost by $5.03, while the entire order placed on Google Express™ will qualify for free shipping if another good worth at least $15.01 is purchased from Target®. The portion of the order placed on Google Express™ to be fulfilled by Walmart® already qualifies for free shipping.

A middleware computer program can be specially programmed to interface with a given e-commerce platform. Such customization may be necessary to ensure that the middleware computer program can simulate interactions with the checkout interface in a convincing manner. As shown in FIGS. 6A-B, the checkout interfaces for different e-commerce platforms will often have different layouts. Accordingly, different middleware computer programs may be responsible for simulating changing in order configurations, applying rebate codes and/or discount codes, entering payment/delivery information, verifying authenticity, etc.

In some embodiments, data may be received from, or transmitted to, an e-commerce platform via an application programming interface (API) or bulk data interface. For example, data regarding the goods available for purchase and the available quantity of those goods may be periodically downloaded from a network-accessible database managed by an e-commerce platform.

Rather than automate the entire negotiation process, an administrator could instead initiate a live negotiation with a counterparty from an e-commerce platform. For example, for bulk orders exceeding a certain size (e.g., 100 units) or value (e.g., $10,000), the administrator may be prompted to manually negotiate with the counterparty. Manual negotiation may lead to lower prices than would otherwise be available, as well as increased flexibility (e.g., the administrator may be better suited to determine whether a suitable replacement exists for a desired good that is not currently available).

### E-Commerce Order Optimization

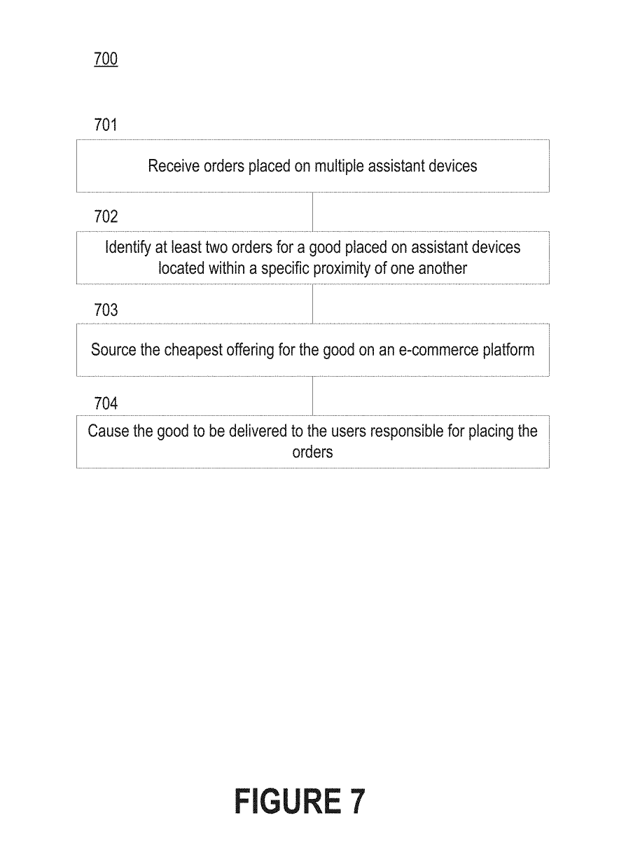

FIG. 7 depicts a process 700 for facilitating location-aware group purchasing that takes advantage of savings from bulk logistics for delivery. Initially, a network-connected server system can receive orders placed on multiple assistant devices arranged throughout different home environments (step 701). These orders can be for different goods, different e-commerce platforms, etc.

The network-connected server system can then examine the orders to identify at least two orders for a substantially similar good that are placed on assistant devices located within a specific proximity of one another (step 702). Generally, the network-connected server system ignores any e-commerce platform preferences specified by the users. For example, the network-connected server system may group a first order requested to be completed using a first e-commerce platform and a second order requested to be completed using a second e-commerce platform, so long as both orders are for the same good. However, in some embodiments, the network-connected server system considers an e-commerce platform preference specified by a user if, for example, the user has an account with an e-commerce platform that would result in some benefit (e.g., free shipping, reduced prices, points for a rewards program).

Moreover, the network-connected server system will typically only group those orders placed on assistant devices located within a specific proximity of one another within a specific time interval. For example, orders may need to be placed within minutes (e.g., 15 minutes, 30 minutes, or 45 minutes), hours (e.g., two hours, four hours, or eight hours), or days (e.g., two days, four days, or seven days) of each other to be included in the same group. In some embodiments, the assistant devices are required to be located in a certain geographical area. Examples of geographical areas include neighborhoods, towns, condominium/apartment buildings, etc. In other embodiments, the assistant devices are required to be located within a predetermined distance of one another (e.g., 5 miles, 10 miles, 20 miles). Thus, the network-connected server system can aggregate localized demand for a certain good.

The boundaries of a geographical area corresponding to a group of orders can vary in an elastic manner. For example, an order for a common good (e.g., toilet paper or coffee) may be combined with other orders placed within the same apartment building, while an order for a less common good (e.g., energy drinks or laundry detergent) may be combined with other orders placed within the same town. The determination of how common a good is may depend on the number of brands available, the differences in quality between those brands, etc.

The network-connected server system can then source the cheapest offering for the desired good that is available on one or more e-commerce platforms (step 703). More specifically, the network-connected server system can separately negotiate with each of the e-commerce platform(s) to establish the lowest price available for the desired good. As noted above, the negotiation process can be completed automatically, manually, or any combination thereof. Additionally or alternatively, the network-connected server system may simulate placing a bulk order on multiple e-commerce platforms, and then identify the e-commerce platform offering the cheapest price.

Thereafter, the network-connected server system can cause the good to be delivered to the users responsible for placing the orders (step 704). In some embodiments, such action requires that the network-connected server system share user information (e.g., financial information and delivery information, such as address) with the e-commerce platform on which the order is placed. For example, the network-connected server system may provide financial information associated with each user to the e-commerce platform, which processes a single transaction with each user using the financial information. Alternatively, the network-connected server system and the e-commerce platform can conduct a single transaction with one another, and then the network-connected server system may process a single transaction with each user using the financial information. In other embodiments, this information may already be available to the e-commerce platform. For example, each user may already have an account for a service associated with the e-commerce platform responsible for sourcing the good.

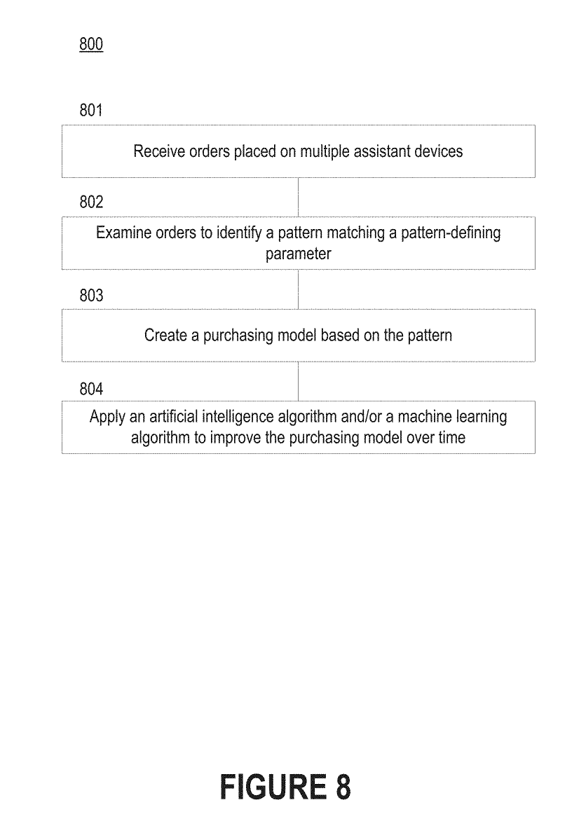

FIG. 8 depicts a process 800 for constructing a purchasing model that predicts the purchasing behaviors of users based on past orders for goods placed through assistant devices. Step 801 of FIG. 8 may be substantially similar to step 701 of FIG. 7.

After receiving orders placed on multiple assistant devices, a network-connected server system may examine the orders to identify a pattern that matches a pattern-defining parameter (step 802). Examples of pattern-defining parameters include order count, order frequency, order cadence, etc. Thus, the network-connected server system may discover that a given user places an order for a certain good every two to three weeks. As another example, the network-connected server system may discover that a given user places orders for a certain good every four weeks during a first time internal (e.g., during winter months) but every two weeks during a second time interval (e.g., during summer months). Patterns can be readily identified that correspond to seasonal purchases, periodic purchases, etc.

Thereafter, the network-connected server system can create a purchasing model based on the pattern (step 803). In some embodiments, the purchasing model is stored in a database that is accessible to the network-connected server system. In such embodiments, the network-connected server system may modify the purchasing model as new orders are received over time. Thus, the purchasing model can be dynamically altered to reflect the current/recent habits of the user(s) responsible for placing the new orders.

The purchasing model may govern how the network-connected server system approaches purchasing the certain good for the given user in the future. When examined in context with other purchasing models corresponding to other users, the network-connected server system can acquire and distribute goods in a more natural, seamless manner. For example, the purchasing models may specify that a first subset of users would like to receive a good at a first cadence (e.g., every two weeks), a second subset of users would like to receive the good at a second cadence (e.g., every three weeks), and a third subset of users would like to receive the good at a third cadence (e.g., every four weeks). Because a separate purchasing model can be maintained for each user, the network-connected server system can ensure goods are delivered to each user at the appropriate cadence.

The network-connected server system may also apply an artificial intelligence algorithm and/or a machine learning algorithm to improve the processes of recognizing patterns, creating purchasing models, etc. (step 804). Examples include Naïve Bayes Classifier algorithms, K Means Clustering algorithms, Support Vector Machine algorithms, linear regression, logic regression, artificial neural networks, etc. These algorithms may be chosen based on application (e.g., supervised or unsupervised learning) and optimized based on how an individual (e.g., a user responsible for placing an order or an administrator responsible for monitoring the network-connected server system) reacts to outputs (e.g., proposed orders) produced by the network-connected server system.

Artificial intelligence algorithm(s) and/or machine learning algorithm(s) may also be employed to achieve predictive aggregation of orders. For example, these algorithms may learn how to more efficiently negotiate price and/or complete purchases with different e-commerce platforms. More specifically, the network-connected server system may discover through the application of various algorithms that certain types of goods are cheaper on a particular e-commerce platform, that a particular e-commerce platform often has deals during certain time intervals (e.g., weekends or holidays), etc.

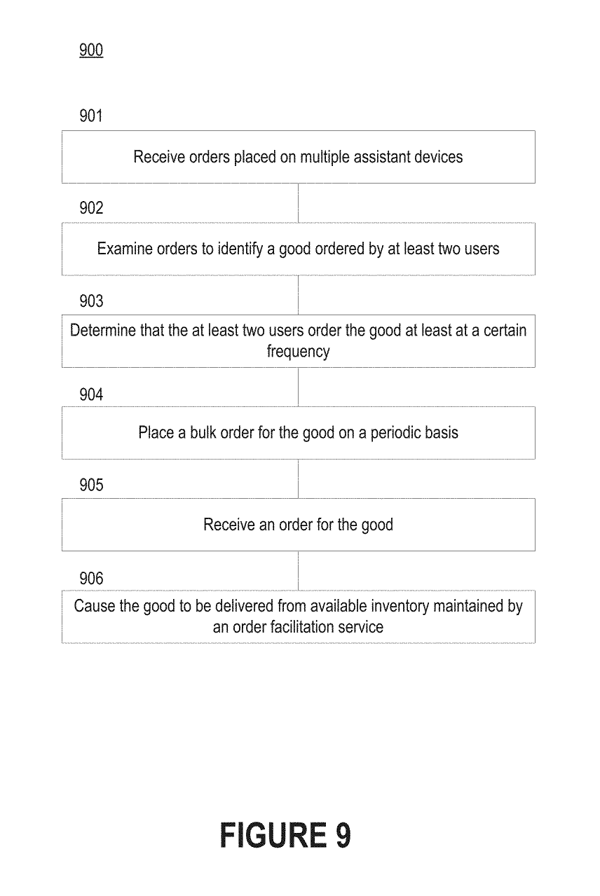

FIG. 9 depicts a process 900 for automatically ordering goods (also referred to as “staple goods”) that are consistently required on a regular basis. These staple goods can be periodically ordered in bulk so that an order facilitation service can quickly fulfill orders for these goods. Because the order facilitation service may maintain its own inventory of a staple good (e.g., bottled water, laundry detergent, or paper towels), orders for the staple good can be fulfilled more quickly than would otherwise be possible. As such, the process 900 may also be referred to as an “auto-replenishment process.”

Initially, a network-connected server system can receive orders placed on multiple assistant devices arranged throughout different home environments (step 901). These orders can be for different goods, different e-commerce platforms, etc. Moreover, these orders can be placed in different geographical locations. For example, the multiple assistant devices may be distributed amongst different towns, counties, states, etc.

The network-connected server system may examine the orders to identify a good ordered by at least two users (step 902), and then determine that these users place orders for the good at a certain frequency (step 903). Said another way, the network-connected server system can analyze the orders to identify staple goods that are ordered at a certain cadence (e.g., at least one every month, two weeks, week, etc.).

As noted above, the network-connected server system may filter the orders so that all orders within the same geographical area are examined together. A geographical area could be defined by a boundary corresponding to a state, a county, a town, a network, a zip code, an area code, geographical coordinates, or any combination thereof. By grouping orders that are placed on assistant devices within a certain proximity of one another, the network-connected server system can readily identify different staple goods corresponding to different geographical areas. For example, a good (e.g., Kirkland Signature® coffee) may considered a staple good in some geographical areas (e.g., the Seattle metropolitan area) but not others. Moreover, even though good may be considered a staple good in two geographical areas, the good may be expected to be delivered at different cadences. For example, the network-connected server system may discover that users located in California place orders for bottled water less frequently than users located in Arizona.

The network-connected server system can also place a bulk order for the good on a periodic basis (step 904). More specifically, the network-connected server system can separately negotiate with one or more e-commerce platforms to establish the lowest price available for the desired good. As noted above, the negotiation process can be completed automatically, manually, or any combination thereof. In some embodiments, the bulk order is placed regardless of how many orders have recently been received for the good. For example, if the network-connected server system determines that a good is typically ordered by approximately 100 users within a county every month, the network-connected server system may automatically place a bulk order for 100 units of the good. This can be done even if only a subset of the users have placed an order that has not yet been fulfilled. In other words, the network-connected server system can intelligently predict which good(s) are frequently ordered by users within a geographical area, and then automatically place orders for those good(s) on a periodic basis to achieve additional per-unit price reductions, logistical savings, etc.

Thereafter, the network-connected server system can receive an order for the good (step 905). Rather than batch the order together with other orders into a bulk order, the network-connected server system can cause the good to be delivered from available inventory maintained by the order facilitation service (step 906). Thus, the order facilitation service may maintain an inventory of staple goods to facilitate quick fulfillment of orders for those goods.

Unless contrary to physical possibility, it is envisioned that the steps described above may be performed in various sequences and combinations. For example, the network-connected server system may simultaneously perform multiple instances of process 700 of FIG. 7 to complete bulk orders for different goods, different groups of users, etc. As another example, in some embodiments the network-connected server system filters incoming orders by geographical location and then desired good, while in other embodiments the network-connected server system filters incoming orders by desired good and then geographical location.

Other steps may also be included in some embodiments. For example, as noted above, the network-connected server system could apply machine learning algorithm(s) and/or artificial intelligence algorithm(s) for several different purposes. First, these algorithms may be applied to identify user preferences, ordering habits, etc. Thus, these algorithms can learn of individuals' needs for household items, thereby creating a more efficient cycle of logistical savings. Second, these algorithms may be applied to discover efficiencies in the ordering process. For instance, the network-connected server system may discover through the simulation of various order configurations that the addition of one or more units to an order will reduce the average price per unit. Similarly, the network-connected server system may discover through the simulation of various order configurations that segmenting the order into multiple sub-orders will reduce the average price per unit.

Due to logical savings, e-commerce platforms may be more likely to bid against one another to offer lower bulk prices for users of the assistant devices. Said another way, because the goods in the bulk order will be delivered within a limited geographical area, the e-commerce platform may offer lower bulk prices.

These lower bulk prices may entice users to purchase assistant devices capable of offering these savings. Machine learning algorithms and/or artificial intelligence algorithms can also create an ever-more efficient cycle of logistical savings for e-commerce platforms and price savings for users of the assistant devices.

### Processing System

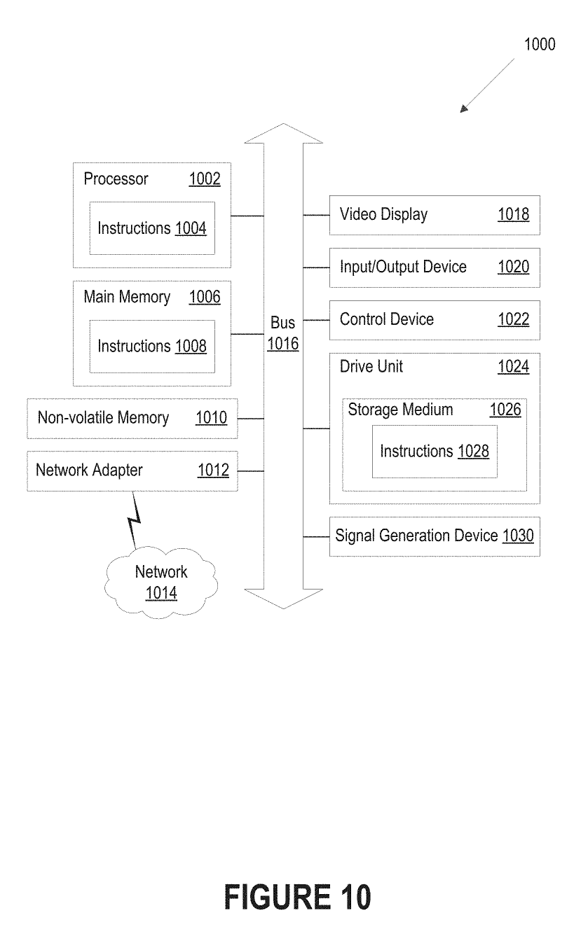

FIG. 10 is a block diagram illustrating an example of a processing system 1000 in which at least some operations described herein can be implemented. For example, some components of the processing system 1000 may be hosted on an assistant device (e.g., assistant device 100 of FIGS. 1A-B) or a network-connected server system (e.g., network-connected server system 208 of FIG. 2).

The processing system 1000 may include one or more central processing units (“processors”) 1002, main memory 1006, non-volatile memory 1010, network adapter 1012 (e.g., network interface), video display 1018, input/output devices 1020, control device 1022 (e.g., keyboard and pointing devices), drive unit 1024 including a storage medium 1026, and signal generation device 1030 that are communicatively connected to a bus 1016. The bus 1016 is illustrated as an abstraction that represents one or more physical buses and/or point-to-point connections that are connected by appropriate bridges, adapters, or controllers. The bus 1016, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The processing system 1000 may share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the processing system 1000.

While the main memory 1006, non-volatile memory 1010, and storage medium 1026 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 1028. The term “machine-readable medium” and “storage medium” shall also be taken to include any medium that is capable of storing, encoding, or carrying a set of instructions for execution by the processing system 1000.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in a computing device. When read and executed by the one or more processors 1002, the instruction(s) cause the processing system 1000 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1010, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 1012 enables the processing system 1000 to mediate data in a network 1014 with an entity that is external to the processing system 1000 through any communication protocol supported by the processing system 1000 and the external entity. The network adapter 1012 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 1012 may include a firewall that governs and/or manages permission to access/proxy data in a computer network, and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A computer-implemented method for generating a bulk order on behalf of multiple users, each of whom has submitted an order using a corresponding assistant device, the computer-implemented method comprising:
receiving multiple orders for a substantially similar good available for purchase from an electronic commerce platform,
wherein each order of the multiple orders is received from a different assistant device of multiple assistant devices;
determining a location of each assistant device of the multiple assistant devices;
dividing the multiple orders into at least two groups based on the locations of the multiple assistant devices,
wherein each group of the at least two groups includes a distinct subset of the multiple orders, and
wherein each distinct subset corresponds to a different geographical area;
discovering, for each group of the at least two groups, a cheapest offering for the substantially similar good available from the electronic commerce platform; and
placing, for each group of the at least two groups, a bulk order for the substantially similar good with the electronic commerce platform,
wherein the bulk orders result in a lower per unit price than would otherwise be available if a separate transaction were completed for each order of the multiple orders.

2. The method of claim 1, wherein said determining comprises:
extracting location information from each order of the multiple orders by parsing data uploaded by each assistant device of the multiple assistant devices.

3. The method of claim 2, wherein the location information specifies a physical address, a state, a county, a town, a network, a zip code, an area code, geographical coordinates, or any combination thereof.

4. The method of claim 1, wherein said determining comprises:
extracting an Internet Protocol (IP) address from each order of the multiple orders by parsing data uploaded by each assistant device of the multiple assistant devices; and
identifying the location of each assistant device by accessing a service that maps IP addresses to location information.

5. The method of claim 1, wherein each group of the at least two groups includes all orders for the substantially similar good placed within a certain time interval within a certain geographical area.

6. The method of claim 1, wherein the certain geographical area is defined by a state boundary, a county boundary, a town boundary, a network boundary, a zip code boundary, an area code boundary, or an area defined by a radius and a geographical coordinate.

7. A method comprising:
receiving, by a network-connected server, multiple orders for goods available for purchase from at least one electronic commerce platform,
wherein each order of the multiple orders is received from a different assistant device of multiple assistant devices;
identifying, by the network-connected server, at least two orders for a certain good that were placed on at least two assistant devices located within a specific proximity of one another;
discovering, by the network-connected server, a cheapest offering for the certain good available from a certain electronic commerce platform of the at least one electronic commerce platform; and
causing, by the network-connected server, the certain good to be delivered to at least two households corresponding to the at least two assistant devices on which the at least two orders were placed.

8. The method of claim 7, wherein the specific proximity corresponds to a county, a town, a network, a zip code, an area code, a building, or an area defined by a radius and a geographical coordinate.

9. The method of claim 7, further comprising:
identifying, by the network-connected server, all orders within the multiple orders that were placed on a particular assistant device;
applying, by the network-connected server, a machine learning algorithm to the orders placed on the particular assistant device to discover a characteristic of a user corresponding to the particular assistant device,
wherein the characteristic is an electronic commerce preference, an order quantity, an order cadence, or any combination thereof; and
estimating, by the network-connected server, a future order for the user based on the characteristic.

10. The method of claim 7, wherein said discovering comprises:
simulating, by the network-connected server, a bulk order on each electronic commerce platform of the at least one electronic commerce platform.

11. The method of claim 10, wherein the bulk order corresponds to one of multiple order configurations that are simulated on each electronic commerce platform of the at least one electronic commerce platform.

12. The method of claim 11, further comprising:
determining, by the network-connected server, that a modification causes the certain good to be available at a lower per unit price; and
applying, by the network-connected server, the modification to the bulk order to secure a lowest possible per unit price for the certain good.

13. The method of claim 12, wherein the modification includes an addition of at least one more good to the bulk order, a segmentation of the bulk order into multiple sub-orders, or an application of a rebate code or a coupon code.

14. An order management platform comprising:
a memory that includes instructions for generating a bulk order on behalf of multiple users, each of whom has submitted a separate order through a corresponding assistant device for a substantially similar good,
wherein the instructions, when executed by a processor, cause the processor to:
for each of multiple electronic commerce platforms,
access an interface on which orders can be placed; and
simulate different order configurations to identify a cheapest offering of a desired quantity of the substantially similar good available for purchase from the multiple electronic commerce platforms;
identify a lowest price for the desired quantity of the substantially similar good from amongst the cheapest offerings available from the multiple electronic commerce platforms;
identify a particular electronic commerce platform corresponding to the lowest price;
initiate a transaction with the particular electronic commerce platform for the desired quantity of the substantially similar good; and
provide a location of each user of the multiple users to the particular electronic commerce platform,
wherein said providing enables the particular electronic commerce platform to facilitate delivery of at least one substantially similar good to each user of the multiple users.

15. The order management platform of claim 14, wherein each order of the multiple orders is for an identical good.

16. The order management platform of claim 14, wherein at least two orders of the multiple orders are for different goods of a similar type and a similar quality.

17. The order management platform of claim 14, wherein the instructions further cause the processor to:
provide user information associated with the multiple users to the particular electronic commerce platform.

18. The order management platform of claim 17, wherein the user information includes credentials for a service associated with the particular electronic commerce platform.

19. The order management platform of claim 17, wherein the user information includes payment information.

20. The order management platform of claim 19, wherein the payment information is used by the particular electronic commerce platform to complete a separate transaction with each user of the multiple users.

21. The order management platform of claim 14, wherein the instructions further cause the processor to:
provide payment information associated with the order management platform to the particular electronic commerce platform,
wherein the payment information is used by the particular electronic commerce platform to complete a single transaction with the order management platform for the desired quantity of the substantially similar good; and
initiate a separate transaction with each user of the multiple users,
wherein each separate transaction involves a transfer of an appropriate amount of money from a corresponding user to the order management platform, and
wherein the appropriate amount of money is based on a quantity of the substantially similar good purchased by the corresponding user.

22. The order management platform of claim 14, wherein the instructions further cause the processor to:
receive multiple orders from multiple assistant devices;
determine that the multiple orders include a first order for a first good and a second order for a second good of a similar type and a similar quality as the first good;
modify the first order so that another of the second good will be purchased to fulfill the first order; and
notify a first user responsible for submitting the first order of the modification to the first order.

23. The order management platform of claim 22, wherein the instructions further cause the processor to:
receive input indicative of an affirmation of the modification to the first order.

24. The order management platform of claim 22, wherein the instructions further cause the processor to:
receive input indicative of a refusal of the modification to the first order; and
remove the first order from the bulk order.

25. A non-transitory computer-readable medium with instructions stored thereon that, when executed by a processor, cause the processor to perform operations comprising:
receiving multiple orders for a good available for purchase from an electronic commerce platform,
wherein the multiple orders are received from a single assistant device;
analyzing the multiple orders to identify a purchasing pattern according to at least a pattern-defining parameter;
creating a purchasing model for the assistant device based on the purchasing pattern; and
predicting an occurrence of a future order for the good based on the purchasing model.

26. The non-transitory computer-readable medium of claim 25, wherein the operations further comprise:
storing the purchasing model in a database; and
modifying the purchasing model as new orders for the good are received from the assistant device.

27. The non-transitory computer-readable medium of claim 25, wherein the operations further comprise:
applying a machine learning algorithm to the purchasing model to discover a characteristic of a user responsible for placing the multiple orders,
wherein the characteristic is an electronic commerce preference, an order quantity, an order cadence, or any combination thereof.

28. The non-transitory computer-readable medium of claim 27, wherein the operations further comprise:
identifying an appropriate advertisement for display on the assistant device based on the characteristic.

29. The non-transitory computer-readable medium of claim 27, wherein the operations further comprise:
generating a notification for display on the assistant device based on the characteristic,
wherein the notification is designed to prompt the user to place a new order for the good.
